(19) United States
(12) Patent Application Publication
(10) Pub. No.: US 2026/0328952 A1
(43) Pub. Date: Oct. 22, 2026

(54) METHOD FOR LOCATING A POINT P IN A RAILWAY SECTION IN A RELATIVE MANNER

(71) Applicant: TRACK MACHINES CONNECTED GESELLSCHAFT M.B.H., Linz (AT)

(72) Inventors: Senen GONZALES, Linz (AT); Leonhard KREIL-BRUNAUER, Pischelsdorf (AT)

(73) Assignee: TRACK MACHINES CONNECTED GESELLSCHAFT M.B.H., Linz (AT)

(21) Appl. No.: 19/104,424

(22) PCT Filed: Aug. 22, 2023
(86) PCT No.: PCT/EP2023/073058

§ 371 Date: Feb. 18, 2025

(30) Foreign Application Priority Data
Aug. 23, 2022 (AT) A50650/2022

(51) Int. Cl. G01S 19/45; B61L 25/02

(52) U.S. Cl. CPC G01S 19/45; B61L 25/026

(57) ABSTRACT

A method of relative localization of a point P on a railway line by measuring a line length lP from an invariant point P1, which railway line comprises a variant first subsection and a subsequent, invariant second subsection, which first subsection extends from a point P1 to a point P4, which second subsection extends from the point P4 and comprises the point P to be localized, which point P is localized in relation from the point P1 at a time t1 by calibrating the line length lP, wherein a changed line length lP between the point P1 and the point P is determined at a time t2, wherein the position of the point P at a time t2 is determined in relation.

### CROSS-REFERENCE TO RELATED APPLICATIONS

The present application is a national phase application of PCT Application No. PCT/EP2023/073058, filed Aug. 22, 2023, entitled “METHOD FOR LOCATING A POINT P IN A RAILWAY SECTION IN A RELATIVE MANNER”, which claims the benefit of Austrian Patent Application No. A50650/2022, filed Aug. 23, 2022, each of which is incorporated by reference in its entirety.

### BACKGROUND OF THE INVENTION

### 1. Field of the Invention

The invention disclosed below relates to a method of relative localization of a point P on a railway line by measuring a line length IP from an invariant point P1.

### 2. Description of the Related Art

Methods of relative localization are known in the prior art.

The point P1 or a further point upstream of the point P1 as seen in the direction of travel may be the point of origin of this relative localization.

The following discussion in based on the simplification that the point P1 is the point of origin and thus a rigid, non-relocatable point. Based on its nature, the point P1 may be a rigid, non-relocatable point in the railway network at least for a period of time, which period of time comprises a first time t1 as mentioned below and a time t2 that is also mentioned.

The methods known in the prior art of relative localization of the same point of a railway line at a first time t1 and at a second time t2, which second time t2 is different from the first time t1 and takes place later than the first time t1, are limited to the railway line not undergoing any change between the point P1 and the point P with regard to the line length lP measured between the point P1 and the point P.

This limitation is explained in the figures description below with reference to the figures.

### SUMMARY OF THE INVENTION

The following definitions serve to support the disclosure of the inventive method: The railway line under consideration comprises a first subsection and a second subsection following the first subsection. The first subsection has a first subsection length l1(t1) at a time t1 and a first subsection length l1(t2) at a time t2, the first subsection length l1(t1) and the first subsection length l1(t2) being different; the first subsection undergoes change of a type not further defined herein between the first time t1 and the second time t2, by which change the length of the first subsection is also changed. Such change in the first subsection may be due, for example, to reconstruction of the railway line in the first subsection.

The disclosure of the invention method is further based on the definition that the first subsection extends from the point P1 (point of origin) to a point P4.

The following definition serves to support the discussion: Unlike the variant first subsection, the second subsection is by definition invariant in length. The second subsection has similar subsection lengths l2(t1)=l2(t2) at a time t1 and at a time t2. The concept of similar subsection lengths l2(t1)=l2(t2) is understood to mean that a change in the second subsection lengths l2 is not measurable and/or does not affect the sufficiently accurate relative localization of the point P.

The second subsection may thus be a subsection invariant between the first time and the second time.

By definition, the second subsection extends from the point P4. The second subsection comprises the point P4 and the point P.

A point or points may be track elements clearly identifiable using measuring sensors, such as a pole, a sleeper or a fixture. A track element preferably extends in a punctiform or angular outline, in particular at a right angle to a track direction, so that a point on the track can be clearly marked by the track element.

The method is based on the observation of multiple points. The points may be defined by different track objects or by repeating track objects such as sleepers or poles, for example.

In the prior art, a P(t1) is localized at a first time t1 from the point P1 by measuring the line length lP(t1) from the point P1 as the point of origin. The line length lP(t1) comprises the first subsection length l1(t1) and a sublength l2P(t1) of the second subsection 2(t1).

A point of origin for relative localization is an invariant, rigid point. Accordingly, the point P1 as point of origin is included in the inventive method as an invariant, rigid point.

The first subsection length l1(t1) at the first time t1 is known. Further known is the second sublength l2P at the first time t1. Since the second subsection is defined as invariant, l2P=l2P(t1)=l2P(t2).

The first subsection length l1(t1) at the first time and the second sublength lP are included in the method described below as known parameters.

If the first subline changed with regard to its subsection length l1 between the first time t1 and the second time t2, the operator would not localize the same point P when measuring the subsection length l1(t1) measured at the first time t1 at a second time; P=P(t1)=P(t2) would not apply. To localize the point P at the time t2, the operator would have to consider the changed subsection length l1(t2). However, no methods are known in the prior art allowing for consideration of the changed subsection length l1(t2) for relative localization of a point P(t2) at a time t2.

WO2019091681[12] merely discloses the usefulness of updating the measured data of a railway network in predefined time intervals. This is by no means a satisfying technical solution for localizing the point P(t1) at a first time t1 or P(t2) at a second time t2. The inventive method allows localization of the same point P(t1)=P(t2) without considering predefined time intervals.

Document WO2022011408 is an earlier patent application by the Applicant and describes a method of creating a database to record various objects of a railway line, with first and second measured values being created using an absolute or relative coordinate reference system. For example, a point C is localized in relation between two fixed points A and B. The measurement location C is described by a first measured value determined using a relative coordinate system. By second measured values based on an absolute coordinate system, the measured values describing a first distance 1 between points A and B at a time t and an alternative distance l′ at a time t′, the measured values can be converted and then compared and/or assigned.

Document WO2020246890 discloses a track monitoring system, in which a processor updates track geometry data recorded in passing based on the geographically referenced position of the rail. A laser imaging unit determines the position of the rail and its environment in relation to the track monitoring system.

Known from document US2006058957 is a system and method for a rail system with an integrated positioning system, in which it can be calculated using distance vectors which of alternative path out of several possible spurs the rail vehicle has taken.

The above documents WO2022011408, WO2020246890, US2006058957 do in no way infringe the novelty of the subject matter described below, nor do they render it obvious.

The solution discussed herein discloses that the first subsection length l1(t2) is measured using the measuring means at the second time, wherein, when the point P4 is invariant, a change in the first subsection (1) is determined by comparing the first subsection length l1(t2) at the first time t1 and the second subsection length l1(t2) at the second time,
wherein the line length lP(t2) between the point P1 and the point P is determined at a second time t2 by adding the first subsection length l1(t2) at the second time t2 to the second sublength l2P,
so that the position of the point P at a time t2 is determined in relation by measuring the line length lP(t2) from the point P1 using the measuring means,
so that a measured value m(t1) determined for the point P(t1) at the time t1 can be assigned to a measured value m(t2) determined for the point P(t2) at the time t2.

This embodiment of the inventive method presupposes that the point P4 is a non-relocatable, rigid point based on its nature. The point P4 may, for example, be a point of a switch or a non-relocatable edifice or a non-relocatable, natural object. Examples of features based on which the point P1 is a rigid, non-relocatable point in the railway network are given in the introduction to the description. Those explanations can also be applied to the point P4. In addition or alternatively to the above description, a tunnel or building or railway crossing is submitted as an example of a non-relocatable edifice. A non-relocatable, natural object may be a river, for example, or generally an object defined by natural parameters.

The point P1 thus is included in the inventive method as a non-relocatable, rigid point.

The first subsection extends between the point P1 and the point P4. The second subsection extends from the point P4; the second subsection comprises the point P4 and the point P to be localized. Since the points P1 and P4 are rigid, non-relocatable points in the embodiment of the inventive method discussed herein, the first subsection and what is the beginning of the second subsection as seen in the direction of travel are predefined. A change in the first subsection length l1(t2) present at the second time as compared to the first subsection length l1(t2) present at the first time may be established by determining the first subsection length l1(t1) at the first time t1 and the first subsection length l1(t2) at the second time t2. Preferably, the first subsection extending between the point P1 and the point P4 is measured in predefined intervals using measuring means such as, by way of example rather than limitation, a measuring coach or measuring wheel and the first subsection length l1 at the predefined times t1 and t2 is thus determined.

In a first method step, only a change in the first subsection length 11 may be established. It is merely established by suitable measuring methods that l1(t1)=/l1(t2). In a second method step, the first subsection length l1(t2) at the second time may be established.

A such separation of the method steps may allow efficient employment of the measuring means. While no particular measuring accuracy is required in the above first method step, the first subsection length l1(t2) has to be determined with sufficient accuracy in the second method step to allow sufficiently accurate localization of the point P at the second time.

Relative localization of the point P(t2) is possible by measuring the line length lp(t2) between P1 and P(t2). The line length lp(t2) is the sum of the measured first section length l1(t2) at the time t2 and the second sublength P2P.

An exemplary embodiment of the inventive method is based on the point P4, in particular the position of the point P4, being known as a non-relocatable, rigid point and being included in the inventive method as such.

A further exemplary embodiment of the inventive method is based on the point P4, in particular the position of the point P4, not being known as a rigid, non-relocatable point. It is part of the inventive method that variant points, in particular the position of the variant points, as well as the invariant, rigid points, in particular the position of the invariant, rigid points, are determined from a plurality of points.

In the context of the disclosure of the invention, a point is regarded as a point invariant with regards to its absolute or relative position, if this point is not recognized as a variant point. The inventive only knows points variant with regard to the absolute and/or relative position and invariant points variant with regard to the absolute and/or relative position.

An exemplary solution based on the present technology is characterized in that a change in the first subsection is determined by a change in position of a point P2 and/or of a point P3 of the first subsection,
wherein the first subsection length l1(t2) at the second time is calculated as the length l2 of a spline extending through the point P1 and the point P4 as well as through the point P2 or P3, respectively, or the second subsection length l1(t2) at the second time is measured using the measuring means,
wherein a line length lP(t2) between the point P1 and the point P at a time t2 is determined by adding the subsection length l1(t2) to the second sublength l2P,
wherein the position of the point P at a time t2 is determined in relation by measuring the line length lP(t2) from the point P1 using the measuring means,
so that a measured value m(t1) determined for the point P at the time t1 can be assigned to a measured value m(t2) determined for the point P at the time t2.

A number of points of the railway line may be observed at the first time t1 and at the second time t2. By way of example, the points P1, P2, P3 and P4 as well as the point to be localized in relation are given in the above discussion.

It follows from the definition of the subsections that the points P1 and P4 are rigid, non-relocatable points. A person of skill in the art may determine and identify the points P1 and P4 as rigid, non-relocatable points from the plurality of observed points. In particular, the skilled person determines and identifies the points P1 and P4 as points having a non-relocatable, rigid position.

The skilled person may determine the points P1 and P4 based on their nature or definition as invariant points. The invariant points may be defined, for example, by an invariant, in particular non-relocatable element such as, for example, a frog, a non-relocatable building etc.

The skilled person may determine and recognize points as invariant points by establishing using prior-art measuring methodology that there is no change in those points with respect to other non-relocatable points such as, for example, reference points of a coordinate system. The skilled person may determine and recognize points as variant points by establishing using prior-art measuring methodology that there is some change in those points with respect to other non-relocatable points such as, for example, reference points of a coordinate system.

For example, the skilled person may establish the absolute coordinates of a point by means of GPS or GNSS.

The skilled person may establish the relative coordinates of a point by measuring in relation to at least one other point. The skilled person may localize a point in relation by measuring the line length in relation to another point such as, for example, a starting point or end point of the railway line.

The skilled person may combine the methods of determining the absolute and relative coordinates and thus the given coordinates with each other.

The skilled person may determine the coordinates at two different times and thereby establish whether the localize point is a variant or invariant point.

The skilled person may localize a plurality of points of a railway line at two different times and establish, by changing the coordinates of those points, whether a localized point is a variant point or an invariant point in the sense of the above definition.

The skilled person may further determine and identify from the plurality of observed points the points P2 and P3 as variant points and thus as points having a variant position.

The skilled person may determine a plurality of points of a railway network at different times, thereby facing the task to divide the plurality of points into invariant points and variant points.

The skilled person compares the coordinates of the plurality of points at the different times. The points having equal coordinates or a change in coordinates within a tolerance range are regarded as invariant points and are included in the inventive method as such. The points having a change in coordinates outside the tolerance range are regarded as variant points.

The skilled person may define the tolerance range with regard to the accuracy of the measuring system used. For example, when GPS is used to determine the coordinates of a point, a tolerance of +/−2.5cm is reasonable, since a GPS system has an inaccuracy of 5.0 cm.

The skilled person may define first partial areas and second partial areas as subsequent partial areas of a railway line depending on the invariant points and the variant points.

Determination of the point P1 as a non-relocatable, rigid point, in particular the position of said point, may be omitted when P1 is the point of origin. Typically, a point of origin is included in a method such as the inventive method as a known point having a known position.

By determining the points P1, P2, P3 and P4, the operator defines the first subsection and the second subsection. By definition, the first subsection is the variant subsection, which first subsection consequently comprises the variant points P2 and P3. The second subsection on the other hand is the invariant subsection, which second subsection consequently has no variant points.

Determination of the points and the subsections also includes identification of the points and subsections, respectively, as such, so that this respective information on points and subsections can be further used in subsequent method steps.

To be able to localized the point P in relation by measuring a line length from the point P1, the line length lP(t2) is determined from the point P1 to the point P at the second time t2. The line length lP(t2) comprises the first subsection length l1(t2) at the second time and the second subsection length l2P=l2P(t1)=l2P(t2).

By applying the current teaching, the operator may calculate the first subsection length l1(t2) as the length of a spline extending through the points P1, P4 as well as

P2 and/or P3. In this, the operator takes into consideration the geometrical side conditions. A potential side condition is that the railway line has no bend in particular in the transition between the first subsection and the second subsection. In other words, the side condition applies that the tangent to the railway line of the first subsection in point P4 and the tangent to the railway line of the second subsection in point 4 run parallel.

In addition or alternatively, the operator may measure the first subsection length l1(t2) at the time t2 using measuring means.

The second sublength l2P does not need to be determined since it is invariant and is included in the inventive method as a known parameter.

The inventive method allows determination of the relative localization of the same point P at different times t1 and t2 as a further technical effect. P=P(t1)=P(t2) applies. It is thereby achieved that a measured value m(t1) determined for the point P at a time t1 can be compared to a measured value m(t2), which measured value m(t2) is determined at the same point P at a second time t2. A change in the railway line can thus be observed in retrospect based on the point P over a period from t1 to t2.

The inventive method allows adapting a database, in particular an indication of a position of the point, to a change in the first subsection between the times t1 and t2. Said database may comprise a plurality of points, which points are included in the inventive method in an exemplary manner as the point P.

Further, a device such as, for example, a maintenance machine may be controlled at the point P based on the measured values m(t1) determined at the first time t1 and the measured values m(t2) determined at the second time t2.

The measured value m(t2) determined for the point P at the second time t2 is comparable to the measured value m(t1) determined for the point P at the first time t1. A railway line can be serviced at the point P based on the measured value m(t1) determined at the first time t1 and based on the measured value m(t2) determined at the second time t2.

The inventive method may be characterized in that a change in the first subsection is determined by a change in dynamic parameters at a position in the first subsection,
which dynamic parameters are determined at the first time t1 and at the second time t2.

The operator may determine the dynamic parameters of a rail vehicle traveling on the first subsection by suitable prior-art sensors. A changed routing of the railway line at a position in the first subsection may, for example, result in changed acceleration values at this position of the first subsection. The operator may determine and compare the dynamic parameters such as acceleration, velocity at a position of the first subsection at the first time and the second time.

The inventive method may be characterized in that a change in the first subsection is determined by a change in the progression of dynamic parameters over the distance of the first subsection,
which dynamic parameters are determined at the first time t1 and at the second time t2. Due to the change in the first subsection between the first time t1 and the second time t2, there is limited opportunity to determine a single position of the first subsection, at which single position the dynamic parameters are determined. The operator may also determine the progression of dynamic parameters and thereby establish a change in the first subsection by comparing the progression of the dynamic parameter when a rail vehicle travels at the first time and at the second time.

The inventive method may be characterized in that the change in the point P2 is determined by determining an absolute position of the point P2 at a time t1 and an absolute position of the point P2 at a time t2, respectively, using GNSS methods.

The inventive method may be characterized in that the change in the point P3 is determined by determining an absolute position of the point P3 at a time t1 and an absolute position of the point P3 at a time t2, respectively, using GNSS methods.

The change in the point P2 and/or the point P3 may be determined by means of GNSS measuring methods. The GNSS measuring methods known in the prior art may be used to exclusively determine the change in the points mentioned. The GNSS measuring methods may be regarded as sufficiently accurate in determining a change in those points.

The inventive method may be characterized in that the change in the point P2 and/or the point P3 is determined by determining relative positions with respect to a measuring mark of the railway line at a time t1 and relative positions with respect to the measuring mark of the railway line at a time t2 using the measuring means.

In railways, relative localization of a point is more accurate than localization of a point using GNS measuring methods. Relative localization allows, for example, to determine variant positions of points.

Preferably, a position of points at a first time t1 and/or at a second time is determined by means of relative localization. The position thus determined may be used in the calculation of the first section length l1(t2) mentioned above.

The method may be characterized in that change in the point P2 and/or the point P3 is performed by comparing a first image to a second image,
wherein the first image shows the point P2(t1) and/or the point P3(t1) at the first time and the second image shows the point P2(t2) and/or the point P3(t2) at the second time.

The first image and the second image may be, for example, an aerial view of the railway line at the first time t1 and at the second time, respectively. Such aerial views can be retrieved via Google Maps. The operator may compare the points P1, P2, P3, P4 in these aerial views and thus determine and identify the variant points P2, P3 as well as the invariant points P1, P4.

In addition or alternatively to at least one aerial view, the skilled person may also use a map of the railway line.

The inventive method may be characterized in that the second sublength l2P either equals or exceeds zero.

The point P4 and the point P may either be the same points (second sublength equalling zero) or different points. The invention is not limited to a special case herein. When the points P and P4 are different, the point P is arranged downstream of the point P4 as seen in the direction of travel.

The disclosure of the inventive method mentions by way of example a variant first subsection and an invariant second subsection, which is basically a simplification of a potential feature of a railway line. The skilled person may also apply the inventive method to railway lines with any order of at least one variant subsection. Since the second sublength l2P may also have the length of zero, an actual second subsection is not at all required to exist.

In the above description, the use of the measuring means is mentioned as a general concept. The skilled person is able to employ adequate measuring means depending on the respective measurement task or the size to be measured.

The inventive method may be characterized in that a railway line is described on the point P by a measured value m(t1) created at the time t1 and a measured value m(t2) created at the time t2.

The inventive method may be characterized in that a rail vehicle is controlled at the point P by a measured value m(t1) created at the time t1 and a measured value m(t2) created at the time t2.

The invention disclosed herein also relates to a database, which database is created according to the inventive method. The database may have user-specific writing rights and reading rights.

The database may comprise indications of a plurality of points, in particular of positions of said points. The invention disclosed herein allows adapting, preferably permanently adapting the database on the position of points, which is discussed herein in an exemplary manner based on the point P.

The invention disclosed herein may be characterized in that the database is stored on a storage medium.

### BRIEF DESCRIPTION OF THE DRAWINGS

The invention will be additionally explained based on the following embodiments shown in the figures:

FIG. 1 shows a schematic representation of a basic outline of a railway line, the present technical problem being shown in FIG. 1.

FIG. 2 schematically shows a basic outline of a railway line to explain the inventive method.

### DETAILED DESCRIPTION

While the embodiments shown in the figures merely show potential embodiments, it should be mentioned at this point that the invention is not limited to these specially represented variant embodiments of the same, but that combinations of the individual variant embodiments among each other and of any one embodiment with the above general description are also possible. Such further potential combinations do not require explicit mention herein, since these further potential combinations are within the skill of the expert in the relevant technical field based on the teaching on technical action by the present invention.

The scope of protection is defined by the claims. The description and the drawings, however, are to be considered in interpreting the claims. Individual features or combinations of features from the different embodiments shown and described may constitute independent inventive solutions of their own. The object underlying such independent inventive solutions may be taken from the description.

In the figures, the following elements are designated by their preceding reference numerals:
1 first subsection
2 second subsection
3 direction of travel

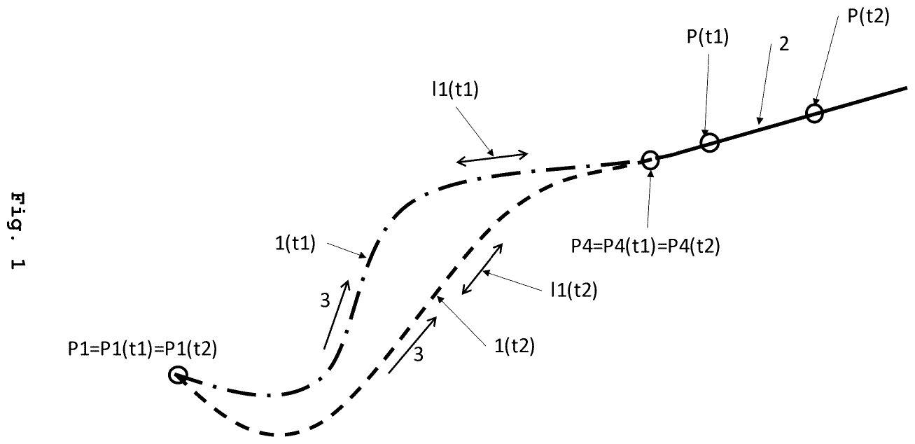

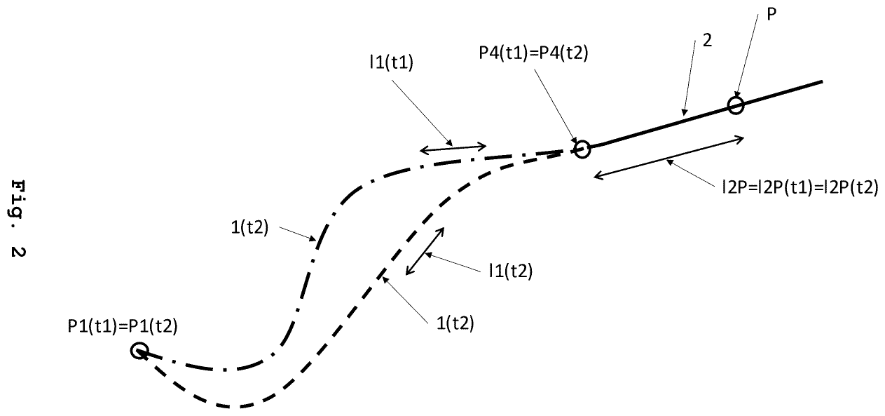

FIGS. 1, 2 and 3 each show schematically a basic outline of a railway line. The method steps of the inventive method and the technical effect of the inventive method are discussed in the following.

The inventive method may be executed as a computer-implemented method. The operator as the skilled person in the field of the invention may determine the measured values required with suitable prior-art sensors by applying methods according to the current teaching. A sensor for determining a measured value may be part of measuring means.

The inventive method is preferably performed as a computer-implemented method when a plurality of variant and invariant points is regarded instead of the points P1 through P4 mentioned by way of example in the context of the disclosure. Due to the measured distances typical in railways or the subsection lengths given herein with a large longitudinal extension, it is impossible for the operator to execute the inventive method as a theoretical method. Typically, subsection lengths are measured over a longitudinal extension of several kilometers and a plurality of variant and invariant points is regarded.

The inventive method may also be applied to a plurality of subsections instead of the two subsections given by way of example in the context of the disclosure, which makes performing the inventive method as a computer-implemented method all the more necessary.

It should be mentioned before the following discussion that sufficiently accurate determination of a position of a point P on a railway line is only possible according to the current teaching via relative localization by measuring a line length lP from a starting point P1. Such sufficiently accurate localization has the problem that any temporal change in the railway line and thus any change in the line length lP(t) between the point P1(t) as the point of origin and the point P(t) renders such relative localization by measuring the line length IP(t) inaccurate. The line length lP(t) is to be regarded as a temporally invariant quantity that needs to be considered in relative localization by measuring the line length lP(t).

The inventive method addresses the technical task to enable such sufficiently accurate, relative localization of a point P(t) at a time t despite any change in the railway line between the points P1 and P12P(t1) by measuring the line length lP(t).

Below as well as in the above description, the points with variant positions, subsection lengths with variant quantities are designated with the additional term (t1) at the first time and with the additional term (t2) at the second time, as is common in the art.

FIG. 1 illustrates the present technical problem.

The railway line comprises a first subsection 1 and a second subsection 2 subsequent to the first subsection 1. The order of the subsections 1, 2 also establishes the direction of travel 3, so that the second subsection 2 follows the first subsection 1 in the direction of travel 3. The direction of travel 3 is regarded as invariant so as not to further complicate the discussion of the invention disclosed herein unnecessarily. It is understood that the inventive method can also be applied with a variant direction of travel 3.

The first subsection 1 extends from the invariant point P1 to the point P4. The second subsection 2 extends from the point P4 and comprises the point P to be localized.

The position of the point P1 and thus the point P4 are invariant; P1=P1(t1)=P1(t2) applies. The point P1 is the point of origin of the relative localization.

The position of the point P4 and thus the point P4 is invariant; P4=P4(t1)=P4(t2) applies.

The point P can be localized in relation at the time t1 by measuring a line length lP(t1). The line length lP(t1) comprises the first subsection length l1(t1) at the time t1 and the second sublength l2P(t1) at the time t1. Such localization is known in the prior art and widely employed in railways, since this relative localization by measuring the line length lP(t1) is regarded as sufficiently accurate.

Since in the prior art the point P can be localized at the first time t1, the first subsection length l1(t1) at the first time t1 is known. Likewise, the second sublength l2P(t1) at the time t1 is known. Since the second subsection 2 is defined as invariant, l2P=l2P(t1)=l2P(t2).

Absolute localization of the point P by means of GPS, for example, is regarded as not sufficiently accurate and also limited to partial areas of the railway line where GPS reception is available.

The first subsection 1 undergoes change between a first time t1 and a second time t2. Such change may be provoked, by way of example rather than limitation, by a change in routing of the first subsection 1.

The point P4 may be arranged at kilometer mark 10.0 at the time t1 and at kilometer mark 12.0 at time t2. This is included in FIGS. 1 through 3 in an exemplary manner.

The first subsection 1 thus has a first subsection length l1(t1) at the time t1 and a first subsection length l1(t 2) at the time t2, the first subsection length l1(t1) and the first subsection length l1(t2) being different.

By definition, the second subsection 2 does not undergo any change between the times t1 and t2.

The second subsection 2 is included in FIG. 1 with a length exceeding zero. However, the inventive method is not limited to this; alternatively, a length of the second subsection 2 equalling zero is also contemplated, so that the point P at the first time t1 and at the second time t2 is arranged on the point P4.

Sufficiently accurate relative localization of the point P in a second subsection 2 subsequent to the first subsection 1 by measuring the line length determined at the time t1 is not possible at the time t2 due to the changed first subsection 1.

If the operator were to determine a point P based on the point P1 by measuring the same line length at a time t1 and at a time t2, they would arrive different points P(t1) and P(t2) at the time t1 and at the time t2, as shown in FIG. 1.

At the same time, the operator is not familiar with any methods according to the current teaching, which methods allow calibrating the point P(t1) and P(t2) while considering the changed first subsection 1.

It is the technical task of the inventive method to ensure localization of the same point P at the different times t1 and t2 even when the first subsection 1 has changed.

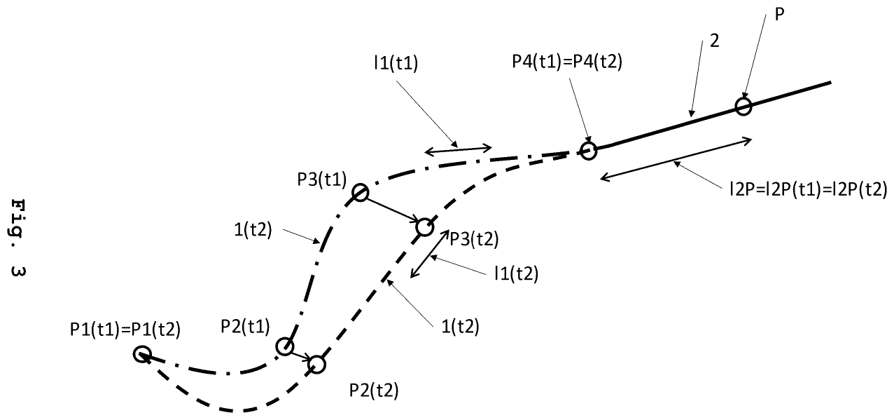

An exemplary method is discussed with reference to FIG. 2. The exemplary inventive method is based on the intelligence that the points P1 and P4 are known as invariant points.

While the railway line shown in FIG. 2 is formed like the railway line shown in FIG. 1, the following additions should be taken into consideration.

In a first method step, a change in the first subsection length l1 between the times t1 and t2 is detected. l1(t1)=/l1(t2) applies. In the exemplary inventive method, this is done by measuring and comparing the first subsection lengths l1 at the different times t1 and t2 by one measuring run each. I.e., one measuring run is performed at the time t1 and another measuring run at the time t2.

Determining the first subsection length l1(t2) at the second time also allows determining the line length lP(t2) between the point P1 and the point P at a second time t2 by adding the first subsection length l1(t2) at the second time t2 to the second sublength l2P. The position of the point P at a time t2 can thus be determined in relation by measuring the line length lP(t2) from the point P1 while considering the changed subsection length l1(t2) at the second time t2.

A further exemplary method is discussed with reference to FIG. 3. The further exemplary inventive method differs from the exemplary inventive method in that the operator does not know the non-relocatable points P1 and P4.

While the railway line shown in FIG. 3 is formed like the railway line shown in FIG. 1, the following additions should be taken into consideration.

The embodiment of the inventive method shown in FIG. 3 comprises a first method step in which a change in the first subsection 1 between the time t1 and the time t2 is detected. For this, it is sufficient to determine a change in the first subsection 1 based on a change in position of the point P2 and/or the point P3. It is included in FIG. 3 by way of example that a change in the first subsection 1 is determined by a change in position of the point P2 and the point P3. It is also possible to only determine the change in position of one point P2 or P3.

The point P2 and the point P3 are points that can be clearly identified on the railway line. The point P2 and the point P3 may be, for example, a point of a sleeper defined by a sleeper code. The skilled person knows further clearly identifiable points of a railway line, such as a point of a switch. The problem of clearly identifying a point of a railway line is not subject to the inventive method discussed herein.

By determining the points with their position changed, here P2 and P3, and the points with their position unchanged, here P1, P4, the first subsection 1 can be determined as a variant subsection of the railway line and the subsection 2 can be determined as an invariant subsection of the railway line.

The skilled person recognizes that by observing multiple points rather than observing the point P2 and/or the point P3 as mentioned herein, accuracy of the division of the railway line into a variant first subsection 1 and an invariant second subsection 2 may be increased.

The change in the point P2 and/or the point P3 may be determined by determining absolute positions at a time t1 and absolute positions at a time t2 for each. The accuracy of GNSS measuring systems is sufficient for determining the change in position of the point P2 and/or the point P3. In an advantageous manner, this mere determination of one change can also be done quickly and easily using GNSS measuring systems.

For example, the GPS position of the point P2(t1) and/or the point P3(t1) at the first time t1 and/or the GPS position of the point P2(t2) and/or the point P3(t2) may be determined as absolute positions.

Determining an absolute position of a point using GPS is generally considered insufficiently accurate in railways. In performing the embodiment of the inventive method described herein, this opinion is overruled, since determining the GPS position of points can be regarded as sufficiently accurate for the purpose of exclusively detecting a change in the first subsection.

Further, the change in the point P2 and/or the point P3 may be determined using images. In addition or alternatively, determination of the variant first subsection 1 and the invariant second subsection 2 using images is regarded as sufficiently accurate.

The change in the point P2 and/or the point P3 may be determined by determining a relative position to a measuring mark of the railway line at a time t1 and a relative position to the measuring mark of the railway line at the time t1 for each.

Determining points having a variant position—here P2, P3—may also include determining points having an invariant position—here P1, P4.

In a further method step, the changed first subsection length l1(t2) at the second time t2 is determined. By definition, the first subsection length l1(t2) at the time t2 is different from the first subsection length l1(t1) at the time t1.

The first subsection length l1(t2) at the time t2 may be calculated while considering the geometrical side conditions. In this, the first subsection may be regarded as a spline. The spline extends through the point P1 and the point P4 as well as through the points P2 and/or P3. Preferably, the tangent of the railway line of the first subsection 1 and the tangent of the railway line of the second subsection 2 run parallel. The latter geometrical side condition allows for consideration of the fact that a railway line, in particular a track course, may not have a bend in its basic outline.

Generally, the first subsection length l1(t2) at the time t2 may also be determined as the length of a polygonal line. Such length determination is, however, regarded as less accurate as compared to the length determination while observing the first subsection length l1(t2) as a spline length.

If the changed position of the point P2 and/or the point P3 is determined by relative localization, such localization of the point P2 and/or the point P3 may be used to calculate the spine, since sufficiently accurate calculation of the first subsection length l1(t2) at the second time t2 is possible in this case.

If no sufficiently accurate positions of the point P2 and/or the point P3 are available, so that the first subsection length l1(t2) at the second time t2 cannot be determined with sufficient accuracy, sufficiently accurate localization of the changed position of the point P2 and/or the point P3 is to be performed by applying measuring methods from the prior art.

Alternatively or additionally to calculating the first subsection length l1(t2) at the second time, the first subsection length l1(t2) at the second time may also be determined by a measuring run.

Knowing the first subsection length l1(t2) at the second time allows relative localization of the point P(t2) at the second time by measuring the line length comprising the first subsection length l1(t2) and the second sublength l2P(t1)=l2P(t2).

The inventive method allows relative localization of the point P(t2) at the time t2 while considering the changed first subsection length l1(t2) at the time t2. The inventive method allows localizing or finding the same point P(t1) at the first time t1 and P(t2) at the second time t2, the position P(t1) and the position P(t2) being identical. P=P(t1)=P(t2) applies.

A measured value m(t1) determined for the point P(t1) at the time t1 can thus be assigned to a measured value m(t2) determined for the same point P(t2) at the time t2.

The inventive methods described based on FIGS. 2 and 3 differ in the type of detecting the change in the first subsection length l1 between the times t1 and t2.

In the exemplary inventive method, the invariant points P1 and P4 are known. It is sufficient to determine the changed first subsection length l1(t2).

In the further exemplary inventive method, the invariant points P1 and P4 are not known. The variant points P2 and/or P3 have to be determined by comparing the changed positions of the points P2 and/or P3 at the first time t1 and at the time t2. Further, the invariant points P1 and P4 have to be determined by comparing the invariant positions of the points P1 and P4 at the first time t1 and at the second time t2.

In the embodiment described based on FIG. 2 and based on FIG. 3, the inventive method has the further technical effect of verifiability or comparability of the measured values determined for the point P(t1), P(t2) at different times t1, t2. For example, a gauge s(t1) determined for the point P(t1) and at the first time t1 can be compared to the gauge s(t2), which gauge s(t2) is determined for the point P(t2)=P(t1) at the time t2.

The inventive method has the further technical effect that not only can a maintenance system be controlled at the time t2 based on the measured values determined at the time t2 but also the measured values determined at a time t1 can also be considered. This allows controlling the maintenance system such as a tamper while considering the temporal change in measured values.

The point P is shown as a point different from the point P4 in the FIGS. 1 through 3. The inventive method is also applicable when the second sublength l2P equals zero and the point P thus equals the point P4.

1-12. (canceled)

13. A method of relative localization of a point P on a railway line, comprising:
measuring a line length lP from the point P1, the railway line comprising a first subsection and a second subsection subsequent to the first subsection, the first subsection comprising a first subsection length l1(t1) at a first time t1 and a first subsection length l1(t 2) at a second time t2, the first subsection length l1(t1) at the first time t1 and the first subsection length l1(t2) at the second time t2 being different, the first subsection extending from the point P1 to a point P4, the second subsection comprising a second subsection length l2(t1) at the first time t1 and a second subsection length l2(t2) at the second time t2, the second subsection length l2(t1) at the first time t1 being equal to the second subsection length l2(t2) at the second time t2, the second subsection extending from the point P4 and comprising the point P; and
measuring a line length lP(t1) from the point P1, the line length lP(t1) comprising the first subsection length l1(t1) and a sublength l2P(t1) of a second subsection 2(t1);
wherein the first subsection length l1(t2) is measured at the second time t2, wherein, when the point P4 is invariant, a change in the first subsection (1) is determined by comparing the first subsection length l1(t2) at the first time t1 and the second subsection length l1(t2) at the second time; and
wherein the line length lP(t2) between the point P1 and the point P is determined at a second time t2 by adding the first subsection length l1(t2) at the second time t2 to the second sublength l2P, the position of the point P at the second time t2 being determined in relation by measuring the line length lP(t2) from the point P1, a measured value m(t1) determined for the point P(t1) at the first time t1 being assigned to a measured value m(t2) attributed to the point P(t2) at the second time t2.

14. The method of claim 13, wherein a change in the first subsection is determined by a change in dynamic parameters for a position in the first subsection, the dynamic parameters being determined at the first time t1 and at the second time t2.

15. The method of claim 13, wherein a change in the first subsection is determined by a change in a progression of dynamic parameters over a distance of the first subsection, the dynamic parameters being determined at the first time t1 and at the second time t2.

20. The method of claim 13, wherein the second sublength l2P equals zero.

21. The method of claim 13, wherein the railway line is described on the point P by the measured value m(t1) created at the first time t1 and the measured value m(t2) created at the second time t2.

22. The method of claim 13, wherein a rail vehicle is controlled at the point P by the measured value m(t1) created at the first time t1 and the measured value m(t2) created at the second time t2.

23. A method of controlling a rail vehicle, wherein a position of the rail vehicle at the point P is determined by the method of claim 13.

24. A method of relative localization of a point P on a railway line, comprising:
measuring a line length IP from the point P1, the railway line comprising a first subsection and second subsection subsequent to the first subsection, the first subsection comprising a first subsection length l1(t1) at a first time t1 and a first subsection length l1(t2) at a second time t2, the first subsection length l1(t1) at the first time t1 and the first subsection length l1(t2) at the second time t2 being different, the first subsection extending from the point P1 to a point P4, the second subsection length l2(t1) at the first time t1 being equal to the second subsection length l2(t2) at the second time t2, the second subsection extending from the point P4 and comprising the point P; and
measuring a line length IP, the line length lP comprising the first subsection length 11 and a sublength l2P of the second subsection;
wherein a first change in the first subsection is determined by a second change in position of at least one of a point P2 and a point P3 of the first subsection;
wherein the first subsection length l1(t2) at the second time t2 is calculated as a length l2 of a spline extending through the point P1 and the point P4 as well as through one of the point P2 and the point P3, respectively, or the second subsection length l2(t2) at the second time t2 is measured;
wherein a line length lP between the point P1 and the point P at the second time t2 is determined by adding the first subsection length l1 to the sublength l2P;
wherein a position of the point P at the second time t2 is determined in relation by calibrating the line length lP from the point P1, a measured value m(t1) determined for the point P at the first time t1 being assigned to a measured value m(t2) determined for the point P at the second time t2.

25. The method of claim 24, wherein a change in the first subsection is determined by a change in dynamic parameters for a position in the first subsection, the dynamic parameters being determined at the first time t1 and at the second time t2.

26. The method of claim 24, wherein a change in the first subsection is determined by a change in a progression of dynamic parameters over a distance of the first subsection, the dynamic parameters being determined at the first time t1 and at the second time t2.

27. The method of claim 26, wherein the second change is determined by determining absolute positions of the point P2 and the point P3, respectively, at the first time t1 and absolute positions of the point P2 and the point P3, respectively, at the second time t2 using GNSS methods.

28. The method of claim 26, wherein the second change is determined by determining relative positions with respect to a measuring mark of the railway line at the first time t1 and relative positions with respect to the measuring mark of the railway line at the second time t2 using measuring means.

29. The method of claim 24, wherein:
the second change is determined by comparing a first image to a second image; and
the first image shows at least one of the point P2 and the point P3 at the first time t1, and the second image shows at least one of the point P2 and the point P3 at the second time t2.

30. The method of claim 24, wherein the second sublength l2P equals zero.

31. The method of claim 24, wherein the railway line is described on the point P by the measured value m(t1) created at the first time t1 and the measured value m(t2) created at the second time t2.

32. The method of claim 24, wherein a rail vehicle is controlled at the point P by the measured value m(t1) created at the first time t1 and the measured value m(t2) created at the second time t2.
